(19) United States
(12) Patent Application Publication
(10) Pub. No.: US 2011/0054952 A1
(43) Pub. Date: Mar. 3, 2011

(54) REMOTE CHECK-IN SYSTEM

(76) Inventor: Craig C. Mateer, Orlando, FL (US)

(21) Appl. No.: 12/550,674

(22) Filed: Aug. 31, 2009

(51) Int. Cl. G06Q 10/00; G06F 17/00

(52) U.S. Cl. 705/5; 235/375

(57) ABSTRACT

An illustrative method for performing a remote check-in service includes receiving accommodation information, where at least a portion of the accommodation information originates from an accommodation provider. The accommodation information includes key information corresponding to an accommodation for a customer. A key is provided to the customer for the accommodation based at least in part on the key information. The key is provided to the customer at a first location of the customer, where the first location is remote from a second location of the accommodation provider.

### BACKGROUND

Whether for work or vacation, every year millions of individuals stay in hotels, on cruise ships, in cabins, and at other accommodations away from home. In most cases, a reservation for the remote accommodation is made in advance to ensure availability upon arrival. When an individual arrives at a remote accommodation for which the individual has a reservation, the individual has to check in, which generally requires the individual to interact with an employee at a service desk of the remote accommodation. In a traditional check in process, the remote accommodation may verify an identity of the individual(s) checking in, receive partial or full payment, place a credit card of the individual on record for incidental costs, receive a security deposit, etc. Depending the accommodation, the time of day, etc., the individual may have to wait in line in order to complete the check in process.

### SUMMARY

An illustrative method for performing a remote check-in service includes receiving accommodation information, where at least a portion of the accommodation information originates from an accommodation provider. The accommodation information includes key information corresponding to an accommodation for a customer. A key is provided to the customer for the accommodation based at least in part on the key information. The key is provided to the customer at a first location of the customer, where the first location is remote from a second location of the accommodation provider.

An illustrative system for performing a remote check-in includes a transceiver and a processor operatively coupled to the transceiver. The transceiver is configured to receive accommodation information, where at least a portion of the accommodation information originates from an accommodation provider. The accommodation information includes key information corresponding to an accommodation for a customer. The processor is configured to activate a key for the accommodation based at least in part on the key information. The key is activated at a first location of the customer, where the first location is remote from a second location of the accommodation provider.

An illustrative tangible computer-readable medium is also provided. The tangible computer-readable medium has computer-executable instructions stored thereon that, if executed by a computing device, cause the computing device to perform a method that includes receiving accommodation information, where at least a portion of the accommodation information originates from an accommodation provider. The accommodation information includes key information corresponding to an accommodation for a customer. A key for the accommodation is activated based at least in part on the key information. The key is activated at a first location of the customer, where the first location is remote from a second location of the accommodation provider.

Other principal features and advantages will become apparent to those skilled in the art upon review of the following drawings, the detailed description, and the appended claims.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a flow diagram illustrating a process for providing a remote check-in service in accordance with a representative embodiment.

FIG. 2 is a flow diagram illustrating a process performed by an accommodation provider in accordance with a representative embodiment.

FIG. 3 is a block diagram illustrating a remote check-in system in accordance with a representative embodiment.

### DETAILED DESCRIPTION

In the following detailed description, reference is made to the accompanying drawings, which form a part hereof. In the drawings, similar symbols typically identify similar components, unless context dictates otherwise. The representative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Described herein are illustrative systems and methods for remote check-in to an accommodation. Prior to departure to the accommodation, a customer is provided with an opportunity to check-in to the accommodation and to receive a room key, a safe key, a mini bar key, a room number, a parking spot number, and/or any other keys or information which allow the customer to access the accommodation in a hassle free manner. The remote check-in can occur at a home of the customer, at a place of employment of the customer, at another accommodation if the customer is changing from one accommodation to another, and/or at any other location desired by the customer. In one embodiment, the remote check-in service is provided by an entity that is distinct from and that cooperates with the accommodation provider. Alternatively, the remote-check-in service may be provided directly by the accommodation provider.

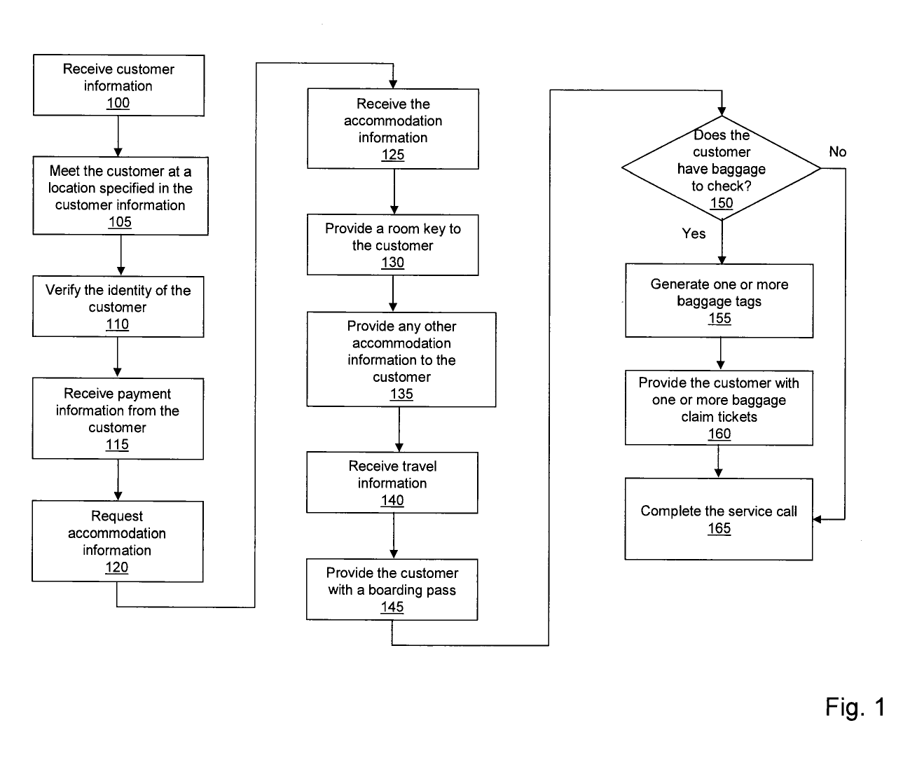

FIG. 1 is a flow diagram illustrating a process for providing a remote check-in service in accordance with a representative embodiment. In alternative embodiments, fewer, additional, and/or different operations may be performed. In an illustrative embodiment, the remote check-in service can be provided by a service company that works in conjunction with one or more accommodation providers. Alternatively, the remote check-in service may be provided directly by an accommodation provider. As used herein, an accommodation can refer to a hotel/motel room, a cruise ship room, a convention center room, a cabin rental, a houseboat rental, a train room rental, and/or any other room or destination to which a customer may check in. Accommodation provider can refer to the hotel/motel, the cruise ship company, convention center, cabin rental company/owner, houseboat owner, train company, etc. that offers the accommodation to the customer.

In an operation 100, customer information is received. The customer information can be received at a portable computing device of a remote check-in service representative. Alternatively, the remote check-in service representative can receive the customer information through printed documentation, verbally, and/or by any other method. The customer information may be provided by an accommodation provider, the customer, and/or any other source, depending on the embodiment. The customer information can include a name of the customer, a location of the customer, an identification of an accommodation at which the customer has a reservation, a flight time of the customer, an airline of the customer, a train departure time of the customer, a check-in date for the accommodation, a check-out date for the accommodation, etc. The location of the customer can be a home address, a work address, a hotel address and room number where the customer is currently staying, a location within an airport from which the customer is travelling to the accommodation, and/or any other address or location at which the customer desires to complete the remote check-in. In one embodiment, at least a portion of the customer information can be provided by the customer to the accommodation provider when the customer makes his/her reservation for the accommodation.

In an operation 105, a remote check-in service representative meets the customer at the location specified in the customer information. The remote check-in service representative can meet the customer at a specified time. The specified time can be established in advance by calling the customer, e-mailing the customer, or otherwise contacting the customer to identify a time that works for both the customer and the remote check-in service representative. Alternatively, the specified time may be set by the accommodation provider, the remote check-in service provider, etc., and provided to the customer. If the specified time is established for the customer, the specified time can take into consideration any flight times, train departure times, other travel times, and/or any other information provided by the customer.

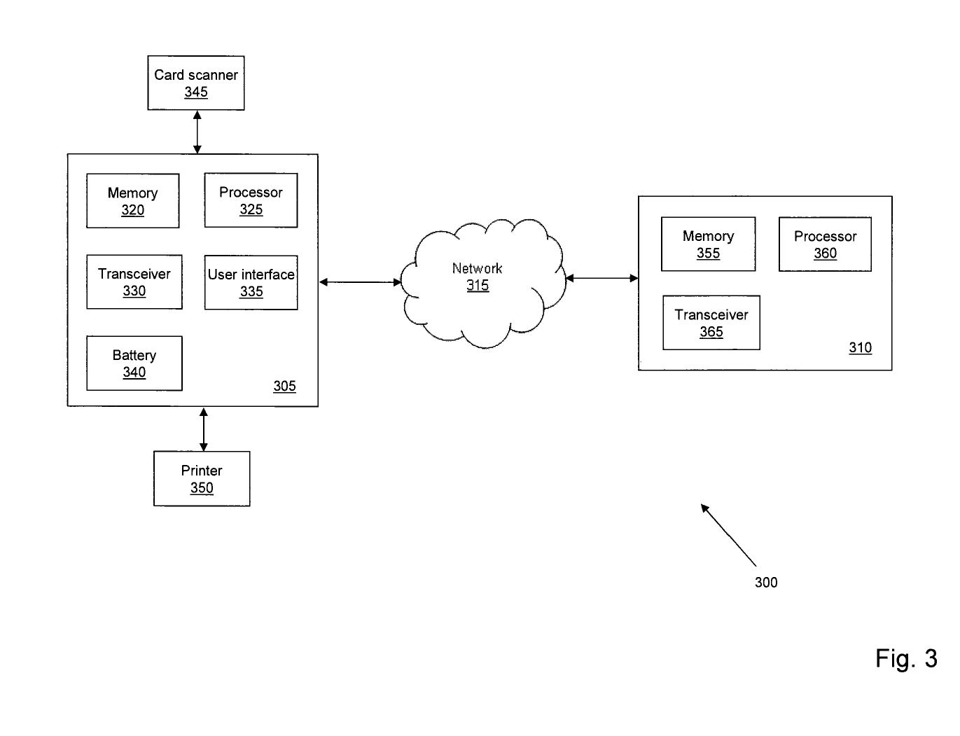

In an operation 110, the remote check-in service representative verifies the identity of the customer. In one embodiment, the remote check-in service representative can visually verify the identity of the customer by examining a photo identification of the customer such as a driver's license, passport, etc. The remote check-in service representative may also electronically verify the identity of the customer by scanning the driver's license, passport, credit card, etc. Electronic identity verification may be performed using with the portable computing device and/or a card scanner. In one embodiment, the card scanner can be incorporated into the portable computing device. The card scanner may also be a standalone device, depending on the embodiment. An illustrative portable computing device and card scanner are described in more detail with reference to FIG. 3. Verification of the identity can also include asking the customer predetermined security questions to which the customer has been provided an answer and/or asking the customer to verify information such as the name of the accommodation provider, the check-in date, the check-out date, any special accommodation requests made by the customer, etc. In one embodiment, the verification information may be provided to the accommodation provider and/or a travel provider for the customer.

In an operation 115, payment information is received from the customer. The payment information can be used to pay for all or a portion of the accommodation, to pay a security deposit associated with the accommodation, to pay for parking at the accommodation, to pay for the remote check-in service, to provide a deposit for any incidental expenses (i.e., room service, bar, restaurant, etc.) incurred at the accommodation, and/or to cover any other expense associated with the accommodation. The remote check-in service representative may receive the payment information in the form of cash, a personal check, a cashier's check, a traveler's check, etc. The payment information may also be received via a credit card, debit card, account number, etc. and processed electronically through a card scanner or the portable computing device. In an alternative embodiment, the payment for the accommodation, the remote check-in service, and other expenses can be made in advance by the customer, and payment information may not be received as part of the remote check-in process.

In an operation 120, accommodation information is requested, and the accommodation information is received in an operation 125. The accommodation information can be requested and received by the remote check-in service representative through the portable computing device. The accommodation information can include a room number assigned to the customer, a time at which the room will be ready for the customer, parking information for the customer, key information, etc. In an illustrative embodiment, the key information can be electronic information that can be used by the portable computing device and the card scanner to encode a magnetic strip of a blank room key such that a room key is generated for the customer. Alternatively, the key information may be a location at which the customer can pick up the room key, instructions for obtaining the room key, etc. The key information can also include information regarding a mini-bar key, a safe key, and any other key associated with the accommodation. In an alternative embodiment, key information may not be included in the accommodation information. In such an embodiment, the remote check-in service representative may be provided with the key(s) prior to arriving at the location of the customer.

The accommodation information can be requested and/or received while the remote check-in service representative is at the location of the customer. Making the request while at the location of the customer, as opposed to in advance, can help provide the accommodation provider with more time to determine which room to assign, whether a key can be provided to the customer, etc. For example, late check-out requests of existing guests, requests by existing guests to stay at the accommodation for additional nights, expected guests that do not arrive, the housekeeping schedule, etc. are all factors that may affect which room is assigned to the customer. Also, for purposes of liability, the accommodation provider may not wish to give a room key to the customer until the room assigned to the customer is vacant. In an alternative embodiment, the accommodation information may be requested and/or received prior to arrival of the remote check-in service representative at the location of the customer.

In an operation 130, a room key is provided to the customer. In an illustrative embodiment, the room key can be generated by using the card scanner and/or the portable computing device to activate a blank room key based on the key information. In one embodiment, the portable computing device can receive the key information as part of the accommodation information. The key information can be electronic information to be encoded onto a magnetic strip of a blank room key. The remote check-in service representative can run the magnetic strip of the blank room key through the card scanner, or the card scanner may automatically run along the magnetic strip. The card scanner can encode the electronic information onto the magnetic strip to activate the room key by any method known to those of skill in the art. A mini-bar key, a safe key, a parking lot key, and/or any other keys may also be activated based on the key information. In one embodiment, a single card scanner can be used to verify the identity of the customer, receive payment from the customer, and activate the room key(s). Alternatively, one or more distinct devices may be used.

The room key can also be a programmable wireless key fob transmitter, and the key information can include an identification of a wireless signal code to be used by the wireless key fob transmitter. In such an embodiment, the portable computing device can establish a wired or wireless connection to the wireless key fob, and can program the wireless key fob with the wireless signal code that corresponds to the accommodation. In one embodiment, the room key can be a metal key, plastic key, wireless key fob transmitter, etc., and the key information can include an identification of the appropriate key to provide to the customer. In another embodiment, the room key can be a key code to be entered into a key pad, and the key code can be included in the key information. In an alternative embodiment, the key information can include specifications for forming a metal key, and the remote check-in service representative can cut and form the metal key by any methods known to those of skill in the art.

In an operation 135, any other accommodation information received from the accommodation provider is provided to the customer. In one embodiment, a printer can be used to print the accommodation information along with a receipt such that the customer has a paper record. The printer can be attached to or in communication with the portable computing device.

In an operation 140, travel information of the customer is received. The travel information can be with respect to a travel reservation made by the customer such that the customer can travel to the accommodation. The travel information, which can be provided by a travel provider, can include boarding pass information for the customer. The travel information can also include a travel itinerary, a time at which the customer is to be at the travel provider, travel alerts, a stall number for a rental car, a number, weight, and/or size of bags that the customer plans to check, etc. The travel provider can be an airline, a passenger train outfit, a bus company, a car rental company, etc. In one embodiment, the travel provider may request identity verification information for the customer prior to providing the travel information.

In an operation 145, the customer is provided with a boarding pass (or ticket) by the remote check-in service representative. In an illustrative embodiment, the portable computing device can utilize a printer to print the boarding pass. The boarding pass can be for an airplane, a train, a bus, and/or any other mode of transportation. If the customer is traveling via a rental car instead of an airplane, train, bus, etc., the customer may be provided with car keys and/or the stall number in which the rental car is located. In an alternative embodiment, the remote check-in service may be provided by a car rental agency such that the customer can obtain his/her rental car and check-in to the accommodation at the same time. In such an embodiment, the remote check-in service may be provided at the location of the customer, or at a location of the car rental agency. In another alternative embodiment, the customer may opt to not utilize the remote check-in for transportation service. In such an embodiment, travel information may not be received and the customer may not be provided with a boarding pass or car keys.

In an operation 150, a determination is made regarding whether the customer has baggage to check. If the customer does not have baggage to check, the service call is completed in an operation 165. Completion of the service call can include providing a confirmation to the accommodation provider and/or travel provider that the customer has completed the remote check-in process. If the customer does have baggage that is going to the accommodation, the remote check-in service representative can receive information regarding the number of bags, the weight of the bags, the size of the bags, whether the bags include fragile materials, etc. The baggage information can be received verbally from the customer, or may be included in he customer information if the customer specified the baggage information in advance.

In an operation 155, the portable computing device can generate one or more baggage tags to be placed on the baggage of the customer. The one or more baggage tags can be generated in conjunction with and on behalf of an airline or other travel provider. Alternatively, the one or more baggage tags may be generated in conjunction with and on behalf of a baggage transport service provider, which can be the same as or different from the remote check-in service provider. The one or more baggage tags can be printed on an adhesive material as known to those of skill in the art. The one or more baggage tags may be printed at the location of the customer, or in advance by the remote check-in service representative if the customer has provided the baggage information in advance. The one or more baggage tags can include a name of the customer, a home address of the customer, a name and address of the accommodation provider, a bag identification number, a time of arrival of the customer at the accommodation, an airline or other travel provider that is to be used by the customer to travel to the accommodation, and/or any other travel or destination information associated with the customer.

In an operation 160, the remote check-in service provider provides the customer with one or more baggage claim tickets. The one or more baggage claim tickets can correspond to the one or more baggage tags and can include any of the information included on the one or more baggage tags. The customer can use the one or more baggage claim tickets to verify that the correct baggage has been delivered to the accommodation. In an illustrative embodiment, the remote computing device can use a printer to print the one or more baggage claim tickets at the location of the customer. Alternatively, the one or more baggage claim tickets can be printed in advance. The remote check-in service provider can take the baggage, and the service call is completed in operation 165.

In an illustrative embodiment, the baggage of the customer can be routed to the accommodation such that the baggage is inside of the customer's room when the customer arrives. In one embodiment, the baggage can be brought to the airport and travel on a flight to the location (i.e., city or nearby city) of the accommodation. The flight can be a same flight used by the customer or a different flight, depending on the embodiment. Alternatively, any other mode of transportation may be used. Once the baggage arrives at the location, a remote check-in service representative can gather the baggage and deliver it to the accommodation provider. The baggage can be placed into the accommodation of the customer by the remote check-in service representative or by an employee of the accommodation provider. Remote baggage check-in and delivery are described in more detail in U.S. Pat. No. 7,512,458 and U.S. patent application Ser. No. 12/371,288 filed on Feb. 13, 2009, the entire disclosures of which are incorporated herein by reference.

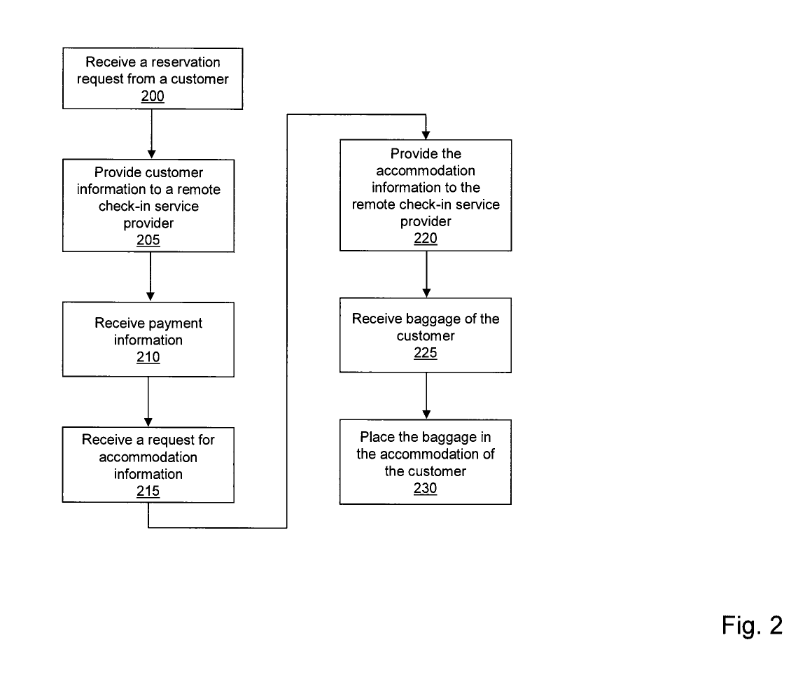

FIG. 2 is a flow diagram illustrating a process performed by an accommodation provider in accordance with a representative embodiment. In alternative embodiments, fewer, additional, and/or different operations may be performed. In an illustrative embodiment, the process can be performed in whole or in part by a computing device that is in communication with a portable computing device of a remote check-in service representative. The computing device is described in more detail with reference to FIG. 3. In an operation 200, a reservation request for an accommodation is received from a customer. The reservation request can be received through a data network such as the Internet, through a telephone, in person, etc. The reservation request can include a name of the customer, a home address of the customer, a telephone number of the customer, payment information of the customer, a type of accommodation requested by the customer, a check-in date and check-out date of the customer, special requests of the customer, etc. The reservation request can also include a location and/or time at which the customer would like to remotely check-in to the accommodation, travel information of the customer, baggage information of the customer, etc. The accommodation provider can process and complete the reservation request according to any methods known to those of skill in the art. In one embodiment, the accommodation provider may provide the customer with a confirmation that confirms the location and/or time of the remote-check in. The accommodation provider may also assign the location and/or time.

In an operation 205, customer information is provided to a remote check-in service provider. The customer information can be provided in response to a request from the remote check-in service provider. The customer information may also be provided automatically based on a check-in date of the customer. The remote check-in service provider may be affiliated with the accommodation provider or a separate entity, depending on the embodiment. The customer information can include any information received from the customer as part of the reservation request. The customer information can also include information regarding whether the customer has completed payment for the accommodation, whether the customer has completed payment for the remote check-in service, etc. In an alternative embodiment, the remote check-in service may be a complimentary service that is paid for by the accommodation provider.

In an operation 210, payment information is received. The payment information can be a credit/debit card number, a credit/debit card expiration date, a three or four digit security code from the back of the credit/debit card, a billing address associated with the credit/debit card, a name as it appears on the credit/debit card, an account number, etc. The payment information can also include an indication that the customer has completed payment with cash, a check, a cashier's check, a traveler's check, etc. The payment information can be used to complete payment for the accommodation, to provide a security deposit, etc. Alternatively, the customer may make a full payment in advance, and payment information may not be received from the remote check-in service provider. In one embodiment, identity verification information of the customer may also be received by the accommodation provider. The identity verification information can include a picture identification of the customer.

In an operation 215, a request for accommodation information is received. The request for the accommodation can be a request for a room/accommodation number at which the customer will be staying, key information for the accommodation, a time at which the accommodation will be ready for the customer, directions or instructions for parking, directions to the accommodation, etc. In an operation 220, the accommodation information is provided to the remote check-in service provider. In an illustrative embodiment, the accommodation information can be provided to the portable computing device of a remote check-in service representative. In an alternative embodiment, the accommodation information may be provided automatically without being requested by the remote check-in service provider.

In an operation 225, baggage of the customer is received. In one embodiment, the remote check-in service provider may deliver the baggage to the accommodation provider in advance of the customer. Alternatively, the baggage may be delivered by any other entity. The baggage may also be picked up from an airport or other travel depot by an employee of the accommodation provider. The baggage is placed into the accommodation of the customer in an operation 230. The baggage can be placed into the accommodation by a remote check-in service representative or by an employee of the accommodation. In an alternative embodiment in which remote baggage check-in is not provided, the baggage may not be received in advance of the arrival of the customer.

FIG. 3 is a block diagram illustrating a remote check-in system in accordance with a representative embodiment. Remote check-in system 300 includes a portable computing device 305 and a computing device 310. In an illustrative embodiment, portable computing device 305 can be used by a remote check-in service provider to provide remote check-in services. Computing device 310 can be utilized by an accommodation provider to help provide the remote check-in services. Portable computing device 305 and computing device 310 can exchange information over a network 315. Network 315 can be a wide area network such as the Internet, a local area network, a wired or wireless telecommunications network, and/or any other data communication network known to those of skill in the art.

Portable computing device 305 can be a laptop computer, a personal digital assistant, a cellular telephone, and/or any other type of portable computing device known to those of skill in the art. Portable computing device 305 includes a memory 320, a processor 325, a transceiver 330, a user interface 335, and a battery 340. In alternative embodiments, portable computing device 305 may include fewer, additional, and/or different components. Each of the components of portable computing device 305 can be operatively coupled to one another according to any methods known to those of skill in the art. Portable computing device 305 is also in wired or wireless communication with a card scanner 345 and a printer 350. In alternative embodiments, card scanner 345 and/or printer 350 can be incorporated into portable computing device 305.

Memory 320 can be used to store customer information, accommodation reservation information, airline information, baggage information, and/or any other data pertaining to a customer or the remote check-in service. Memory 320 can also be used to store computer-readable instructions that, when executed, cause portable computing device 305 to perform any of the operations described herein for providing the remote check-in service. Processor 325 can be configured to execute the computer-readable instructions. Processor 325 can also be configured to communicate with and/or control card scanner 330, transceiver 335, and printer 340.

Transceiver 330 can be used to receive and/or transmit information through network 315. In an illustrative embodiment, transceiver 330 can communicate with a transceiver 365 of computing device 310. As an example, transceiver 330 can receive customer information, reservation information, accommodation information, baggage information, etc. from transceiver 365. Transceiver 330 can also transmit identity verification data, payment information, baggage information, etc. to transceiver 365. Transceiver 330 can further communicate with a computing device (not shown) associated with an airline to receive or transmit flight information, identity verification information, baggage information, etc. In an illustrative embodiment, transceiver 330 can be an internal or external modem. Transceiver 330 may also be any other receiving component and/or transmitting component known to those of skill in the art. User interface 335 can include a computer mouse, a keyboard, a display, a touch screen, a touch pad, and/or any other component that allows a remote check-in service representative and/or customer to interact with portable computing device 305. Battery 340 can be used to provide power to portable computing device, and can be any type of portable power source known to those of skill in the art.

Card scanner 345 can be used to scan picture identification cards and/or credit/debit cards for the purpose of verifying the identity of the customer. Card scanner 345 can also be used to scan credit/debit cards for the purpose of receiving payment information from the customer for the accommodation and/or for the remote check-in service. If used to receive payment information, card scanner 345 may include a separate user interface to allow the customer to enter a personal identification number (PIN), provide a signature, etc. Alternatively, user interface 335 may be used by the customer to enter the PIN, signature, etc. Card scanner 345 can further be used to scan a blank room key and encode key information onto the blank room key to activate a room key for the customer. In alternative embodiments, a plurality of card scanners may be used to perform different tasks. Printer 350 can be used to print receipts, confirmations, accommodation information, baggage tags, baggage claim tickets, boarding passes, driving/walking directions, and/or any other information which a remote check-in service representative may provide to the customer. In an illustrative embodiment, card scanner 345 and printer 350 can be accessory devices that communicate with portable computing device 305 through a wired or wireless connection. Alternatively, card scanner 345 and/or printer 350 can be incorporated into portable computing device 305.

Computing device 310 includes a memory 355, a processor 360, and transceiver 365. In alternative embodiments, computing device 310 can include fewer, additional, and/or different components. For example, computing device 310 may also include a user interface, a battery, a printer, etc. Computing device 310 can be a desktop computer, a laptop computer, a wireless communications device, a server, and/or any other type of computing device known to those of skill in the art. In an illustrative embodiment, memory 355 can be configured to store customer information, reservation information, baggage information, and/or any other data pertaining to a customer or the remote check-in service. Memory 320 can also be used to store computer-readable instructions that, when executed, cause computing device 310 to perform any of the operations described herein for providing the remote check-in service. Processor 360 can be configured to execute the computer-readable instructions. Processor 360 can also be configured to communicate with and/or control transceiver 365 and any other components of computing device 310.

Transceiver 365 can be used to receive and/or transmit information through network 315. In an illustrative embodiment, transceiver 365 can communicate with transceiver 330 of portable computing device 305. As an example, transceiver 365 can receive customer identity verification information, payment information, baggage information, etc. from transceiver 330. Transceiver 365 can also transmit customer information, reservation information, accommodation information, baggage information, etc. to transceiver 300. In an illustrative embodiment, transceiver 365 can be an internal or external modem. Transceiver 365 may also be any other receiving component and/or transmitting component known to those of skill in the art.

In one embodiment, portable computing device 305 may be permanently or removably mounted to a vehicle utilized by a remote check-in service representative. In an alternative embodiment, portable computing device 305 may be implemented as a kiosk that allows the customer to perform the remote check-in at a kiosk location. The kiosk location can be in an airport, at a train station, at a car rental agency, in a hotel lobby, and/or at any other location. In such an embodiment, the customer can travel to the kiosk location and perform the remote check-in without the assistance of a remote check-in service representative. Alternatively, a remote check-in service representative may be present to assist the customer with the remote check-in.

As an example of remote check-in through a kiosk, a customer can approach the kiosk and authenticate. Authentication can be via scanning a credit/debit card or driver's license, by entering a username and password and/or any other information, and/or by providing biometric information such as an eye scan, voice recognition, fingerprint scan, etc. Once authenticated, the customer may be prompted to enter payment information through a credit or debit card, account number, etc. The kiosk can process the payment information and receive accommodation information from computing device 310 or any other source. The kiosk can use a card scanner and key information to generate a room key for the customer by encoding the key information onto a blank key. Alternatively, the kiosk may program a wireless key fob transmitter based on the key information, cut and form a metal key based on the key information, receive a key code in the key information, etc. The key can be provided to the customer along with a printout that includes the accommodation room number, a check-in time, walking directions, etc.

One or more flow diagrams have been used herein. The use of flow diagrams is not meant to be limiting with respect to the order of operations performed. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method for performing a remote check-in service, the method comprising:
receiving accommodation information, wherein at least a portion of the accommodation information originates from an accommodation provider, and wherein the accommodation information includes key information corresponding to an accommodation for a customer;
providing a key to the customer for the accommodation based at least in part on the key information, wherein the key is provided to the customer at a first location of the customer, and wherein the first location is remote from a second location of the accommodation provider.

2. The method of claim 1, further comprising:
receiving identity information from the customer; and
verifying an identity of the customer based at least in part on the identity information.

3. The method of claim 1, further comprising:
receiving payment information from the customer; and
providing the payment information to the accommodation provider, wherein the payment information is used to pay for at least a portion of the accommodation.

4. The method of claim 1, further comprising activating the key by encoding the key information onto a magnetic strip of a blank key.

5. The method of claim 1, further comprising:
receiving travel information corresponding to the customer; and
providing a boarding pass to the customer, wherein the boarding pass is based at least in part on the travel information.

6. The method of claim 1, further comprising:
receiving baggage information corresponding to one or more bags of the customer; and
generating one or more baggage tags for the one or more bags based at least in part on the baggage information.

7. The method of claim 6, further comprising providing the customer with one or more baggage claim tickets corresponding to the one or more baggage tags.

8. The method of claim 6, further comprising routing the one or more bags to the accommodation.

9. The method of claim 1, wherein the accommodation information further includes a room number assigned to the customer.

10. A system for performing a remote check-in, comprising:
a transceiver, wherein the transceiver is configured to receive accommodation information, wherein at least a portion of the accommodation information originates from an accommodation provider, and wherein the accommodation information includes key information corresponding to an accommodation for a customer; and
a processor operatively coupled to the transceiver, wherein the processor is configured to activate a key for the accommodation based at least in part on the key information, wherein the key is activated at a first location of the customer, and further wherein the first location is remote from a second location of the accommodation provider.

11. The system of claim 10, wherein the transceiver is further configured to transmit identity verification information to the accommodation provider.

12. The system of claim 10, further comprising a card scanner operatively coupled to the processor, wherein the processor uses the card scanner to activate the key.

13. The system of claim 10, wherein the accommodation information further includes a room number assigned to the customer and a time at which the accommodation will be ready for the customer.

14. The system of claim 10, wherein the key comprises a wireless transmitter.

15. The system of claim 10, further comprising a printer configured to generate one or more baggage tags for the customer.

16. The system of claim 10, wherein the processor and the transceiver are incorporated into a kiosk that is accessible by the customer.

17. A tangible computer-readable medium having stored thereon, computer-executable instructions that, if executed by a computing device, cause the computing device to perform a method comprising:
receiving accommodation information, wherein at least a portion of the accommodation information originates from an accommodation provider, and wherein the accommodation information includes key information corresponding to an accommodation for a customer; and
activating a key for the accommodation based at least in part on the key information, wherein the key is activated at a first location of the customer, and wherein the first location is remote from a second location of the accommodation provider.

18. The tangible computer-readable medium of claim 17, further comprising:
receiving baggage information corresponding to one or more bags of the customer; and
generating one or more baggage tags for the one or more bags based at least in part on the baggage information.

19. The tangible computer-readable medium of claim 17, further comprising:
receiving identity information from the customer; and
verifying an identity of the customer based at least in part on the identity information.

20. The tangible computer-readable medium of claim 17, further comprising receiving the first location of the customer.
